(19) United States
(12) Patent Application Publication
(10) Pub. No.: US 2004/0108163 A1
(43) Pub. Date: Jun. 10, 2004

(54) Emergency ladder system and method of use

(76) Inventor: Donald Ole Johnson, Menomonie, WI (US)

Correspondence Address: DONALD O. JOHNSON, 207 24th AVE. WEST, MENOMONIE, WI, 54751, US

(21) Appl. No.: 10/646,427

(22) Filed: Aug. 21, 2003

Related U.S. Application Data
(60) Provisional application No. 60/405,262, filed on Aug. 22, 2002.

(51) Int. Cl. A62B 1/06

(52) U.S. Cl. 182/70

(57) ABSTRACT

An emergency ladder system and housing assembly developed to provide an alternative route of exit from a multi-story structure in case of a fire or other emergency. The system is designed to mount within the stud wall cavity below an escape opening such as a window. The system is comprised of an enclosure and ladder assembly, which is stowed within the enclosure when not in use. The enclosure door doubles as a step when opened. This provides a person during an emergency a platform to step onto after exiting the escape opening. Additionally, the door can be covered with a material matching the exterior wall of the structure such as siding.

### CROSS-REFERENCE TO RELATED APPLICATIONS, IF ANY

This application claims the benefit under 35 U.S.C. .sctn. 119 (e) of co-pending provisional application Serial No. 60/405,262, filed Aug. 22, 2002. application Serial No. 60/405,262 is hereby incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

1. Field of the Invention

The present invention relates to an emergency ladder system. More particularly, the emergency ladder system that mounts within the exterior wall of a structure.

| | |
|---|---|
| Current U.S. Class: | 182/76; 182/70 |
| Intern'l Class: | A62B 001/06 |
| Field of Search: | 182/70, 73, 76, 84, 196 248/201 |

### REFERENCES CITED: [Referenced By]

U.S. Patent Documents

| | | | |
|---|---|---|---|
| 6129178 | May., 1999 | Shupp | 182/76 |
| 5842539 | Jul., 1996 | Hough | 182/70 |
| 5664642 | Aug., 1996 | Williams | 182/70 |
| 4127184 | Dec., 1977 | Strohmeyer | 182/70 |
| 6135239 | Oct., 1997 | Martin | 182/70 |
| 5064021 | Apr., 1990 | Bauer | 182/73 |
| 4381046 | Dec., 1980 | Lamdem | 182/70 |
| 5012892 | Jul., 1989 | Kelly | 182/84 |
| 5020633 | Feb., 1990 | Rangel | 182/70 |
| 5467841 | Jun., 1994 | Krumal | 182/70 |
| 4445589 | May., 1983 | Longenecker | 182/76 |
| 4164991 | Apr., 1978 | Marra | 182/70 |

2. Background Information

There has long existed a demand for emergency ladder system, which provides an alternative route of exit from a multi-story structure in case of a fire or other emergency. Many patents disclose inventions that intend to fulfill the need for said ladders. An example of such an emergency ladder system is U.S. Pat. No. 6,129,178 to Shupp, which discloses an escape ladder and housing assembly, adapted to the framework in the wall of a structure below an escape opening.

This escape ladder and housing includes a door associated with housing side walls to close said front opening of said housing so as to enclose ladder construction.

U.S. Pat. No. 5,842,539 to Hough discloses a fire escape assembly, which is mounted within a structure. The ladder, which is enclosed within the housing, is dispensed through the window.

U.S. Pat. No. 5,664,642 to Williams discloses a fire evacuation kit comprising a housing mounted inside a residence below a window, said housing contains a rope ladder, fire extinguisher, flashlight and respiration mask, said rope ladder is dispensed through the window.

U.S. Pat. No. 4,127,184 to Strohmeyer discloses a combination window box and fire escape comprising an enclosure mounted external to the residence, said window box holds a collapsible ladder.

U.S. Pat. No. 6,135,239 to Martin discloses a self-contained fire escape apparatus adapted for mounting within a building wall, comprising a collapsible ladder, which is dispensed through the window.

U.S. Pat. No. 5,012,892 to Kelly discloses an escape ladder assembly comprising a framework structure mounted external to the residence, plurality of interconnected ladder sections, a means of connection and a platform carried by said framework.

Despite a myriad of patents having addressed the need for an emergency escape ladder system, there still remains the need for an escape ladder system, which provides a substantial sized platform in which a person could exit a window onto, turn around and descend down an enclosed ladder. Additionally, the previously named patents fail to provide a step that doubles as the door for the enclosure and can be covered to match the exterior of the structure.

### BRIEF SUMMARY OF THE INVENTION

The Emergency Ladder System has been developed to provide an alternative route of exit from a multi-story structure in case of a fire or other emergency. The system is designed to mount within the wall cavity framed in a structure either during new construction or in an existing structure. The system is designed to be non-obtrusive on the exterior of a structure since it can be sided to match the exterior of the structure. The main concept behind the system is the step. The door of the ladder system doubles as a step when opened. This allows a person, during an emergency, to step out of the window and place their feed onto the platform created by the door. By providing the individual with a step, he or she will be able to exit the window, turn around and descend the ladder to the ground during an emergency. The system would contain a collapsible ladder assembly of sufficient length for a person to descend to the ground safely.

### BRIEF DESCRIPTION OF THE SEVERAL VIEWS OF THE DRAWING

FIG. 1 is a front partial perspective view of the embodiment of the invention wherein the hinged door is in the open position and the ladder is deployed.

FIG. 2 is a front partial perspective view of the invention in FIG. 1 with hidden lines viewed.

FIG. 3 is a front perspective view of the Enclosure Frame and hinged Door Frame of one embodiment of the invention.

FIG. 4 is a rear perspective view of the Enclosure Frame and hinged Door Frame of one embodiment of the invention.

FIG. 5 is a front perspective view of the invention with the hinged door in the open position and the insulation panels and ladder removed.

FIG. 6 is a side view of invention in FIG. 5 wherein the hinged door is in the open position.

FIG. 7 is a front perspective view of the invention in FIG. 1 just before installation within the stud wall of a structure.

FIG. 8 is a front perspective view of one embodiment of the invention while mounted within the wall of a structure and sided to match the exterior of the structure. It is shown in the closed position.

FIG. 9 is a front perspective view of one embodiment of the invention while mounted within the wall of a structure and sided to match the exterior of the structure. It is shown in the open position with the ladder deployed.

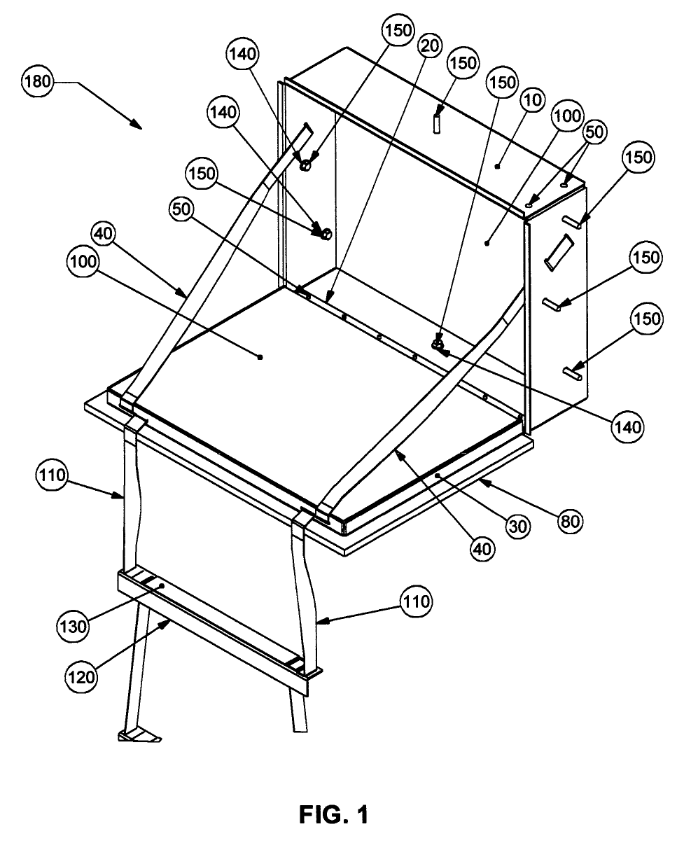

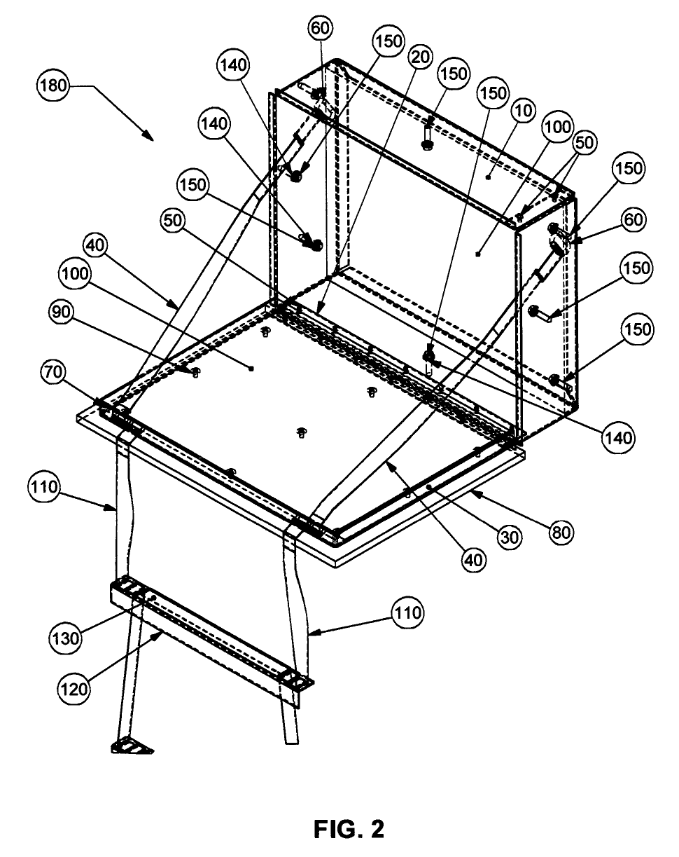

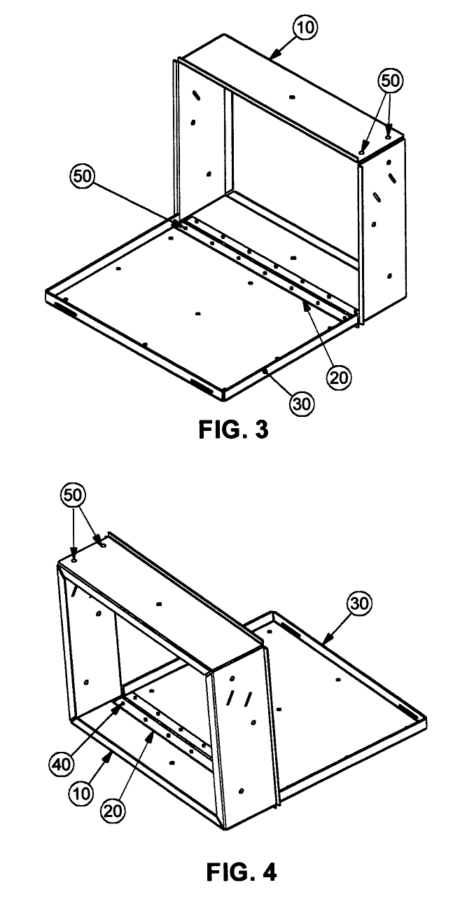

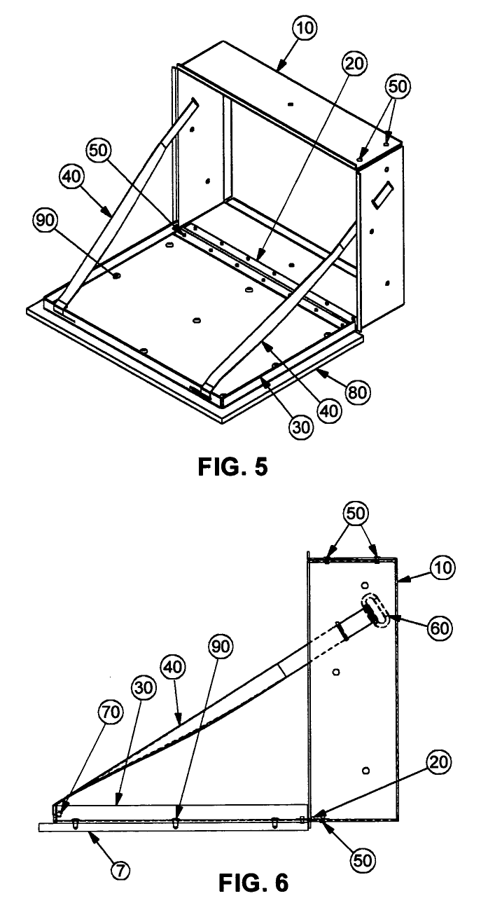

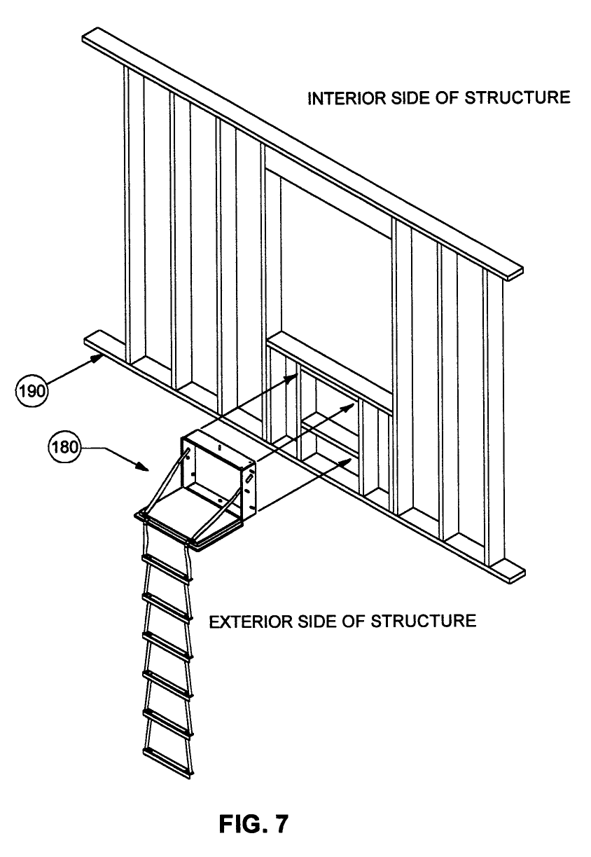

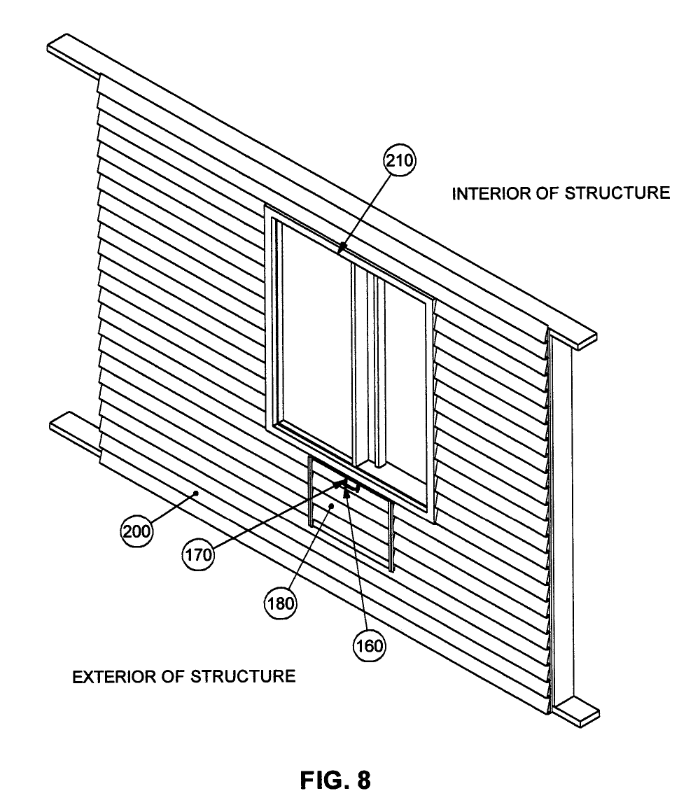

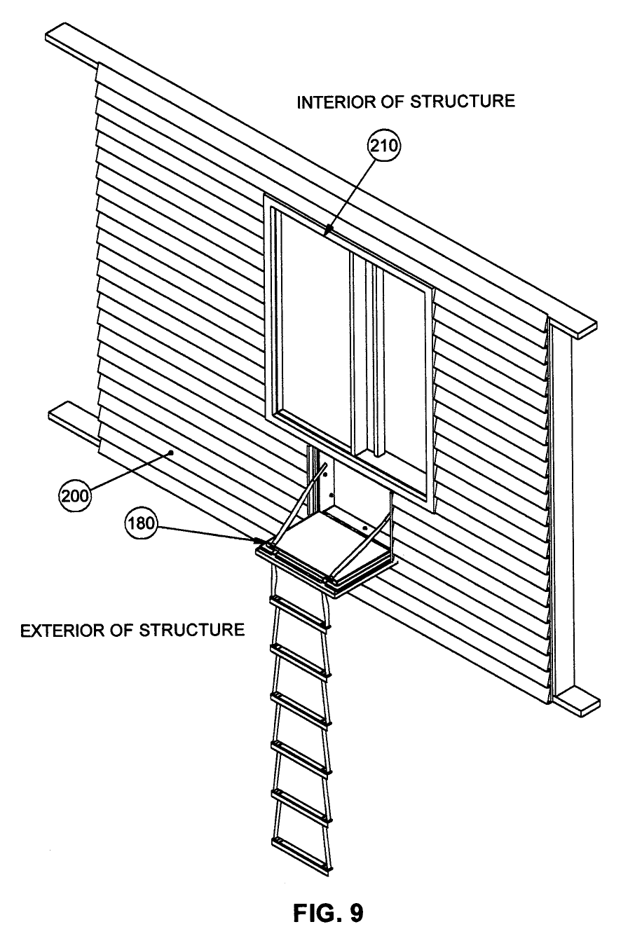

### DETAILED DESCRIPTION OF THE INVENTION INCLUDING A BEST MODE

Definitions

As utilized herein, “essentially horizontal” refers to being at an angle equal to or less than 20 degrees relative to gravity.

Construction and Use

Concept

The Emergency Ladder System has been developed to provide an alternative route of exit from a multi-story structure in case of a fire or other emergency. The system is designed to be mounted into the exterior stud wall cavity framed in a structure either during new construction or in an existing structure. The system is designed to be non-obtrusive on the exterior of a structure since the door of the system can be sided to match the exterior of the structure. The main concept behind the system is the door, which doubles as a step. The door of the ladder system doubles as a step when opened. This allows a person, during an emergency, to step out of the window and place their feet onto the step created by opening the door. By providing the individual with a step, he or she will be able to exit the window, turn around and descend the ladder to the ground during an emergency. The ladder assembly should provide a sufficient number of rungs to descend to the ground safely.

Installation

The Emergency Ladder System should be mounted into a cavity within the exterior wall of a structure. The cavity is typically framed in with wooden 2×6 studs. The cavity should be framed in below a window on an upper level floor. The Emergency Ladder System is then slid into the cavity from the exterior of the wall and fastened in place. The preferred fastener is a lag bolt. The lag bolts are inserted through holes in the enclosure frame. The lag bolts are threaded into the sides of the studs until the walls of the enclosure frame are drawn tight to the studs. The door should be provided with a solid panel, which should be essentially flush with the exterior sheeting attached to the structure. The panel is preferably made of wood or plastic. The door panel can be sided to match the exterior of the structure so as to blend in with the exterior of the structure when not in use.

Use

The following procedure is the preferred method of use of the system.

1. Open or break the window under which the Emergency Ladder System is installed.

2. Reach out of the window and pull the handle on the door of the escape system to open the door, which provides a step.

3. Pushed the collapsed ladder assembly off the step. The ladder will then extract to provide a sufficient number of rungs to safely descend the ladder to the ground.

4. The exiting person will then step out of the window and onto the step provided by the door of the Emergency Ladder System.

5. The person will be able to turn around and climb down the ladder assembly.

6. After use, the ladder system can be collapsed again and stowed within the ladder assembly. This is if the ladder system has not been damaged during the emergency or use of said ladder.

PREFERRED METHOD OF CONSTRUCTION

Materials

| Item # | Qty | Description | Material | Optional Materials |
|---|---|---|---|---|
| 10 | 1 | Enclosure Frame | Aluminum | Carbon Steel, |
| | | | | Stainless Steel, |
| | | | | Wood |
| 20 | 1 | Continuous Hinge | Aluminum | Carbon Steel, |
| | | | | Stainless Steel. |
| | | | | Brass |
| 30 | 1 | Door Frame Panel | Aluminum | Carbon Steel, |
| | | | | Stainless Steel, |
| | | | | Plastic, Wood |
| 40 | 2 | Door Support Strap | Nylon Webbing | Braided Wire, |
| | | | | Chain, Rope |
| 50 | 16 | Pop Rivet | Aluminum | Carbon Steel, |
| | | | | Stainless Steel |
| 60 | 2 | Door Support Strap Retainer | Carbon Steel | Stainless Steel, |
| | | | | Aluminum |
| 70 | 1 | Strap Retaining Rod | Stainless Steel | Carbon Steel, |
| | | | | Aluminum, Wood |
| 80 | 1 | Outer Door Panel | Exterior CDX | Wood Treated, |
| | | | | Plywood, Plastic, |
| | | | | or similar products |
| 90 | 9 | Wood Screw | Zinc Plated Steel | Stainless Steel |
| 100 | 2 | Insulation Panel | Foil Faced Foam | Fiberglass |
| | | | Insulation Panel | Insulation, |
| | | | | Polystyrene, |
| | | | | Wood, or similar |
| | | | | insulating |
| | | | | materials |
| 110 | 2 | Ladder Support Strap | Nylon Webbing | Braided Wire, |
| | | | | Chain or Rope |
| 120 | 12 | Ladder Rung | Aluminum | Stainless Steel, |
| | | | | Carbon Steel, |
| | | | | Wood or flat or |
| | | | | round rungs made |
| | | | | of similar materials |
| 130 | 12 | Anti-Slip Pad | Anti-Slip Tape | Any other similar |
| | | | | material or coating |
| | | | | consisting of slip |
| | | | | resistant |
| | | | | ingredients |
| 140 | 8 | Flat Washer | Zinc Plated Steel | Stainless Steel, |
| | | | | Aluminum |
| 150 | 8 | Lag Screw | Zinc Plated Steel | Stainless Steel, |
| | | | | Aluminum |
| 160 | 1 | Door Pull | Carbon Steel - | Brass, Wood, |
| | | | Powder Coated | Aluminum, |
| | | | | Stainless Steel |
| 170 | 4 | Wood Screw - Oval Head | Zinc Plated Steel | Brass, Stainless |
| | | | | Steel, Aluminum |
| 180 | 1 | Emergency Ladder System | | |
| 190 | 1 | Stud Wall of a Structure | | |
| 200 | 1 | Sided Wall of a Structure | | |
| 210 | 1 | Window of a Structure | | |

Steps of Construction

The following is the preferred method of construction.

Step 1

The Enclosure Frame (Item 10) is the first item constructed. This is made typically of punched and brake formed aluminum. It can be made in either one or two pieces and the corners are connected via the Pop Rivets (Item 50). This will form the rectangular structure. The clearance holes for rivets, lag screws and nylon webbing is pre-punched prior to brake forming.

Step 2

The Door Frame Panel (Item 30) is constructed secondly. This is made typically of punched and brake formed aluminum. It can be made of one piece of aluminum sheet, which has the clearance holes pre-punched for the wood screws and pop rivets along with the slots for the nylon webbing. Next, side and front flanges are brake formed to create perpendicular members, which provide strength and a cavity for later installed insulation panel.

Step 3

The Continuous Hinge (Item 20) is cut to length from purchased aluminum hinge material. It is then attached to the lower horizontal member of the Enclosure Frame and similarly to the Door Frame Panel. The preferred method of attachment is pop riveting. This provides rotation of the Door Frame Panel from the closed to open positions. The Continuous Hinge is preferably spaced evenly between the vertical side members of the Enclosure Frame. Attention is paid to verify correct fit of Door Frame Panel within the Enclosure Frame while in the closed position.

Step 4

The Outer Door Panel (Item 80) is cut to size and attached to the exterior surface of the Door Frame Panel. The preferred method of attachment is with Wood Screws (Item 90). This panel is typically made of exterior sheeting (building plywood). Location of said panel with respect to the Door Frame Panel must be spaced evenly in the horizontal plane. It must also be positioned vertically in such a position as to allow the door to open to the essentially horizontal position. The purpose of the Outer Door Panel is first provide added strength to the step capable of supporting a person and secondly to allow material such as siding to be attached to the exterior to match that of the structure. This panel can also be made of standard lumber, plastic or other material, which will allow adequate strength as a step along with the ability to attach material such as siding.

Step 5

The Ladder Rung (Item 120) is made from aluminum flat stock and cut to required size. It is pre-punched or laser cut with apertures that are essentially evenly spaced at each end of said rung. Apertures provide openings of which the nylon webbing can pass through. After the apertures are completed the material is brake formed into a L-shape. The L-shape provides strength to said rung.

Step 6

The Anti-Slip Pad (Item 130) is cut to length. This pad can be made from purchased anti-slip tape. The pad is then adhered to the uppermost horizontal surface of the ladder rung with adhesive. It provides the person exiting the structure with a surface that will reduce the chance of slipping. This surface can be replaced with any suitable material that will resist slip or paint or powder coating, which contains material that hinder slip.

Step 7

The ladder is preferably made with nylon webbing and ladder rungs. The Ladder Support Straps (Item 110) are cut to length. Then the first end is measured, marked and loops are created. Loops can be either sewn or ultrasonically welded or connected via a mechanical fastener. The after the loop is created on the first end the second end is woven through slots punched in the Ladder Rungs (Item 120). Said second end is continually fed through the slots in all rungs and the remainder is left hanging unattached. The preferred spacing for the rungs is 12″ intervals. These rungs could also be replaced with flat surface rungs, cylindrical rungs or wooden dowels. The webbing could also be replaced with wire rope (cable), chain, or rope. Some modifications must be made if substitute materials or rungs are utilized.

Step 8

The Strap Retaining Rod (Item 70) is cut to length This rod is made from material capable of supporting a sizable lad, yet small enough to fit under the insulation panel of the door. The Strap Retaining Rod's purpose is to secure the ends of the Door Support Strap (Item 40) and the Ladder Support Strap (Item 110). After inserting the rod through the nylon loops, the rod is laid in position. The insulation panel then holds it in place. The rod allows the easy removal of the nylon webbing if it becomes deteriorated or damaged. This rod is typically made of stainless steel, but could be replaced with other materials such as carbon steel, wood or aluminum.

Step 9

The Door Support Strap (Item 40) is cut to length. The preferred material is nylon webbing. Loops are then created at both ends either via sewing, ultrasonic welding or mechanical fastener. The loops provide a means of attachment to the enclosure and door frame. First end is passed through the slots provided in the enclosure and the Door Support Strap Retainer (Item 60) is passed through the loop and secured in place. The Door Support Strap Retainer facilitates the easy removal of the nylon straps if they become damaged or deteriorated. The second end is then passed through the slots within the Door Frame Panel and onto the Strap Retaining Rod. These straps must be able to support the entire load applied by both the step and ladder assembly along with the additional load of the exiting persons. They can also be made from wire rope (cable), chain or rope. Some modifications must be made if substitute material is used.

Step 10

The Insulation Panels (Item 100) can be cut to size and assemble next. Preferably two insulation panels are cut to size to friction fit within the Door Frame Panel and the Enclosure Frame. These insulation panels replace the thermal protection for the structure that was removed due to the cavity created for the Enclosure Frame. Clear silicone or its equivalent can be applied to the surfaces of the enclosure/door assembly where the insulation panels contact. This provides a seal and holds the insulation in place. The insulation panels are positioned and pressed into place to adhere to the silicone. Silicone can be eliminated if friction fit holds insulation securely in place. The preferred material for the insulation panels is foil faced foam insulation. This can be substituted with pink polystyrene or fiberglass batting insulation or any other suitable material.

Step 11

The Ladder Assembly is then collapsed and placed within the enclosure. The mounting hardware and door handle and instructions are stowed within the enclosure for shipping.

Step 12

The System is installed in a structure. The door handle is attached to the exterior of the door after the material, such as siding, has been applied in the field.

What I claim is:

1. An assembly, comprising:
(a) an apparatus, comprising;
(i) a frame mounted within an exterior wall of structure below an escape opening such as a window; and
(ii) a hinged door pivotally attached to the frame, wherein the door pivots away from the window from a closed position wherein the door is essentially horizontal when in the open position and allows access to an interior storage chamber defined by the assembly, and (2) provides a step outside the structure, said door is supported via a support member which collapses within the chamber while in the closed position, said support member is attached at the first end to said enclosure, said support member is attached at the second end to said door through spaced apart apertures; and
(b) a collapsible ladder having a first end attached to the door through spaced apart apertures.

2. An assembly as recited in paragraph 1, wherein the hinged door has an interior surface and an exterior surface, and the exterior surface of the door is covered with a material matching the exterior wall of the structure.

3. A method of use, comprising the steps of:
(a) opening a window in a structure to provide an opening through the structure; and
(b) pivoting a hinged door on an assembly installed below the window on the structure form a closed position to open position wherein the door is essentially horizontal when in the open position and allows access to an interior storage chamber defined by the assembly; and
(c) removing a collapsible ladder from the storage chamber wherein a first end of the ladder is attached to the door; and
(d) allowing a second end of the ladder to drop downwardly from the door; and
(e) stepping through the window onto the door; and
(f) descending the ladder.
